(19) United States
(12) Patent Application Publication
(10) Pub. No.: US 2004/0234803 A1
(43) Pub. Date: Nov. 25, 2004

(54) Absorbent composites: manufacture of pseudo-fibertm natural fibers and forming of multi-fiber compsites for strength, insulation, sound, fluids and odor absorbency

(76) Inventor: Catherine Joyce, Portsmouth, NH (US)

Correspondence Address: Catherine Joyce, P.O. Box 4314, Portsmouth, NH, 03802, US

(21) Appl. No.: 10/643,706

(22) Filed: Aug. 19, 2003

Related U.S. Application Data
(63) Continuation-in-part of application No. 09/887,503, filed on Jun. 22, 2001, now abandoned.
Application No. 09/887,503 is a continuation of application No. 09/389,573, filed on Sep. 3, 1999, now abandoned.
(60) Provisional application No. 60/137,147, filed on Jun. 1, 1999.
(60) Provisional application No. 60/136,609, filed on May 27, 1999.

(51) Int. Cl. B32B 3/00

(52) U.S. Cl. 428/537.1

(57) ABSTRACT

Multi-fiber composites consist of a combinant structure of cellulosic wood and/or non-wood or polymeric fibers which are mixed with non-fibrous materials and/or waste materials and processed to form Pseudo-Fiber™ natural fibers. They offer economic and environmental efficiencies to wood, non-wood papermaking, polymeric and other composite operations, including construction composites as in the making of concrete, etc. They also provide useful, multivarious functional fiber properties necessary or desired in the manufacture of, but not limited to, automotive, construction, disposable cups, packaging, food and non-food packaging; disposable hygiene products of diapers, feminine care, incontinence; disposable medical products of wound dressings, surgical gowns and drapes; personal care and filtration products.

### STATEMENT REGARDING FEDERALLY SPONSORED RESEARCH OR DEVELOPMENT

This invention was not made by an agency of the United States Government or under a contract with an agency of the United States Government.

### SPECIFICATION

1. Background—Field of Invention

This invention relates to the low-cost manufacture of new Pseudo-Fiber™ natural fibers to be utilized in composites for improved absorption of heat, sound, fluids and odors. Invention is stock material [layers] covered under Class 428 and Class 16, paper fiber, for trademark purposes.

This new fiber offers superior thermal absorption in the manufacture of disposable cups, food and non-food packaging; absorption of sound and thermal in automotive products/panels; absorption of odors and fluids while maintaining wet-web integrity in disposable hygiene products of diapers, feminine care, incontinence and disposable medical products of wound dressings, surgical gowns and drapes; personal care and filtration products.

2. Background—Discussion of Prior Art

There appears to be no prior art for utilization, processing or fiber-engineering of this new fiber made from non-fibrous waste materials, in its preferred embodiment as outlined in this patent.

Historically all fibers normally used in the manufacture of paper consist of wood pulp and other cellulosic fibers such as flax, hemp, kenaf, bagasse, cotton, sisal, kapok, eucalyptus, abaca, ramie, wheat and rayon, or polymeric fibers, utilizing a “chemically treated or mechanically [‘cooked’]” process. I utilize these waste materials in an “uncooked” process. These waste materials have never been added in an unprocessed, or “uncooked” method before. Many unsuccessful attempts have been made by paper manufacturers to work with bast fibers, but not these waste materials. Manufacturers, Academics or Papermakers' first reaction is always that cellulosic fibers will damage their specialized equipment.

This non-fibrous waste material exists in all of the above cellulosic fibers and are the result of fiber processing [dew or water retting] or decortication, by separating the outerbark [epidermis] from the woody, central cylinder which adheres to the innermost core, pith or lumen, of the fiber plant. Cellulosic fibers compose from 20% to 35% of all fiber plants; while resulting waste materials from fiber processing compose the remaining 65% to 80%. This essentially unusable waste material from fiber processing is traditionally shipped to papermakers to wet-process [cook or chemically treat] as fillers, along with its wood pulp. These fillers add very little to the papermaking yields achieved. This disposal method does not add value to end-use products, e.g., paper and nonwovens, or fully utilize the economic and efficiency potential for this valuable, non-fibrous waste material. To date, these waste materials have only found a byproduct market niche of animal bedding, most popular in Europe, and now the U.S. and Canada.

It is this innermost non-fibrous waste material of woody “core” or “pith” that is the subject of this patent. Each cellulosic fiber plant uses a different term to identify this waste. For example, in flax it is called “shive”; in hemp it is called “hurd”; in kenaf it is called “core”; in jute it is called “butts”, etc.

Fiber Harvesting Techniques

Non-wood, cellulosic fibers are harvested using a dew-retted or water-retted process. Dew-retting is now the most common method as it preserves the greatest yield of usable fiber. Water-retting can lead to under-retting to produce gummy residue which makes the fiber separation form the woody core, difficult, besides weakening the fibers; or over-retting which also weakens fibers. In both cases of water-retted fibers, significant damage is done to fiber yields, contributing to increased fiber waste materials being under-utilized.

Utilization of these non-fibrous waste materials has been slow, or non-existent, other than using hemp hurds, in its de-corticated state of non-fibrous tubular structure, for animal bedding, and more recently as wood substitutes in tubular form, in building products of oriented strand board (OSB) or particleboard to simulate wood.

In the case of kenaf core, it is cooked or chemically processed, and used on a limited basis in papermaking, specifically for newsprint, as it holds up better than hemp hurds or flax shives in papermaking. Nonetheless, kenaf core is still under-utilized as it shares similar physical properties of hemp hurd, yet lacks the appropriate process to fully utilize this non-fibrous waste material for the purposes of disposable cups, food and non-food packaging, hygiene and medical products, personal care and filtration.

In the case of a difficult furnish such as bagasse [from sugarcane], technological limits have prevented making paper with such a weak furnish. Recently, India's persistence in using alternative fibers to save timberlands, paid off when Voit Sulzer Paper Technology designed a new machine to handle this difficult furnish. Voith has also designed a new press for using 100% eucalyptus furnish in Brazil.

Historically, technological constraints have always precipitated breakthroughs in fiber engineering. Both papermaking and nonwovens industries have always sought wet-processing solutions, even though a dry-processing solution is necessary here to achieve full utilization of these non-fibrous waste materials.

By fiber-engineering our new Pseudo-Fiber™ natural fibers from non-fibrous waste materials, with or without binders, and combining them in both dry and wet-processing methods, paper and polymeric fiber makers, and nonwoven manufacturers will be able to utilize non-fibrous waste materials to make new multi-fiber composites to increase their profit margins and satisfy consumer demand for natural fiber products; lower their operating costs; offer environmental benefits of reduced forestation and landfills; and put a large segment of sustainable, non-wood resources of non-fibrous waste materials to good use.

Utilization of these new man-made fibers provide the opportunity to sell paper and nonwovens at premium prices because of the functionality of these new absorbent composites for odor control, fluids, thermal-resistance, and sound attenuation, etc., rather than adding expensive chemicals or polymers to simulate these natural attributes inherent in some of these fibers.

Economic Comparison with Other Materials

Pseudo-Fiber™ natural fiber family offers low-cost efficiencies and costs average $180/Ton [$U.S.]; and $100/Ton for Type B, respectively. Alternative wood and non-wood fiber resources all cost considerably more. Bleached Pulp, Eucalyptus and Southern Pine sells for $325-480/Ton, while higher quality pulp ranges $500-$650/Ton, and specially treated pulp for $1700-$2700/Ton, as pulp industry is recovering. For pulp and paper manufacturers to

[symbol]

In the case of a difficult furnish such as bagasse [from sugarcane], technological limits have prevented making paper with such a weak furnish. Recently, India's persistence in using alternative fibers to save timberlands, paid off when Voit Sulzer Paper Technology designed a new machine to handle this difficult furnish. Voith has also designed a new press for using 100% eucalyptus furnish in Brazil.

Historically, technological constraints have always precipitated breakthroughs in fiber engineering. Both papermaking and nonwovens industries have always sought wet-processing solutions, even though a dry-processing solution is necessary here to achieve full utilization of these non-fibrous waste materials.

By fiber-engineering our new Pseudo-Fiber™ natural fibers from non-fibrous waste materials, with or without binders, and combining them in both dry and wet-processing methods, paper and polymeric fiber makers, and nonwoven manufacturers will be able to utilize non-fibrous waste materials to make new multi-fiber composites to increase their profit margins and satisfy consumer demand for natural fiber products; lower their operating costs; offer environmental benefits of reduced forestation and landfills; and put a large segment of sustainable, non-wood resources of non-fibrous waste materials to good use.

Utilization of these new man-made fibers provide the opportunity to sell paper and nonwovens at premium prices because of the functionality of these new absorbent composites for odor control, fluids, thermal-resistance, and sound attenuation, etc., rather than adding expensive chemicals or polymers to simulate these natural attributes inherent in some of these fibers.

Economic Comparison with Other Materials

Pseudo-Fiber™ natural fiber family offers low-cost efficiencies and costs average $180/Ton [$U.S.]; and $100/Ton for Type B, respectively. Alternative wood and non-wood fiber resources all cost considerably more. Bleached Pulp, Eucalyptus and Southern Pine sells for $325-480/Ton, while higher quality pulp ranges $500-$650/Ton, and specially treated pulp for $1700-$2700/Ton, as pulp industry is recovering. For pulp and paper manufacturers to

[symbol]

Given all their efforts, they have still not achieved preferred attribute goals of thermal-resistance, strength, absorption, and other functional properties from these fibers alone, and continue to search for alternatives. A case in point is Starbucks' and Solo's 3-year search for an environmental, biodegradable cup equivalent to a “double-cup” thermal-resistance factor, without styrene components. Paper disposable cup manufacturers have only 15% of the existing market, and continue to lose business steadily to polymer (foam) cup manufacturers who have 85% of the 45 Billion cups/year disposable cup market. Foam cup technology is an inefficient insulator, yet yields lower uneven material surface temperatures than paper.

A thermal-resistance test on this new fiber composite using both wood pulp and hemp pulp, individually, as a base for a combinant structure, achieved thermal results surpassing Starbucks' double-cup thermal-conductivity result by 12%+. ASTM Testing of thermal-resistance vs Material Density yielded significant positive results using this invention of composite waste materials. An analytical chart demonstrated this technology could move paper cup manufacturers 70% closer to present foam cup manufacturers in production and thermal results.

Disposable cup production is not a precise measurement and differences in material density and weight result because of the inattention to precise quality manufacturing standards, which would add considerable cost to the low-margin cup manufacturing process. This new fiber technology in this invention is a very “forgiving” process and allows for differences in cup manufacturing standards, thus maintaining lower operating costs, with minimal effort.

Legal Requirements:

Novelty: Dry processing of wood and non-wood cellulosic fibers to create new fiber technology from fibrous and non-fibrous waste materials.

Unobvious: By using a new, unconventional processing method of “not mechanically or chemically-treating” fibers, an exceptional thermal result occurs, as in the case of disposable cup technology. Variations on this theme result in new innovations in absorbent composites for sound, thermal, fluids and odor control.

Utility: The usefulness of this new fiber-engineering is evident in Objects and Advantages Section.

Class: It is a new composition of matter and a process for engineering new fibers from non-fibrous waste materials, and multiple composites resulting therefrom.

### OBJECTS AND ADVANTAGES

Accordingly, several objects and advantages of fiber-engineering Pseudo-Fiber™ natural fibers from non-fibrous waste materials, using combinant wet and dry processing techniques, are:

increases utilization of non-fibrous waste materials;

offers non-toxic, environmental alternatives to wood resources

reduces operating costs of papermakers, nonwoven manufacturers and polymeric operations;

offers manufacturers premium pricing structure for low cost endproducts

satisfies consumer demand for less de-forestation; & more natural fiber product offerings

promotes non-fibrous waste materials' functional properties included in some cellulosic materials, such as sound attenuators, odor control, thermal, fluids absorption, etc.

adds value to non-fibrous waste materials, regardless of inferior fiber processing, harvesting and sub-standard manufacturing process techniques

non-fibrous waste materials are sustainable, non-wood resources and readily available

non-fibrous waste materials are low-cost alternatives[$100-$180/Ton vs $325-$2500/Ton]

offers flexibility to design end-use products on exact specifications and functionality

Preferred Embodiment

Step One: Separation

Separation by processing of core, pith, hurds, shives, et al., the essentially non-fibrous waste materials derived from the processing of cellulosic fibers of wood and non-wood fibers of hemp, flax, kenaf, cotton, ramie, abaca, sisal, kapok, bagasse, eucalyptus, wheat and rayon, to effect the manufacture of “Pseudo-Fibers™” natural fibers. Usual and customary separation of fiber processes are dew and water retting, decortication, chemical or similar.

Step Two: Dry Processing:

A. Reduction of Core, Pith, Hurd, Shive, et al., or Essentially Non-Fibrous Waste Materials.

a. Hammermill, beater, pulverizer, holomoid or similar, to mechanically reduce the size of essentially non-fibrous waste materials. Several grinder screen sizes are preferred, most specifically 0.063, 0.040 and 0.027 inches, or any other grinder screen size as preferred.

b. Screening, sifting, and further processing of reduced, fibrous and non-fibrous waste materials.

Combinant Structure

This novel process combines the processed, refined, cellulosic and or polymeric fibers with the processed, refined and further processed fibrous and non-fibrous waste materials to form a multi-fiber substrate.

These fibers may, or may not, be dry-blended with synthetic or cellulosic fibers, polymers or chemical additives.

These new fibers are to be dispersed in a pulper, or similar dispersing apparatus suitable to manufacture, and then that dispersion, blended in the fan pump, or other suitable mixing point, prior to deposit in or on, web structure or other, in substrate manufacture.

Substrate Formation

Multi-fiber substrate formation, when used with processed Pseudo-Fiber™ natural fibers, offers the paper and nonwovens industries, an unusual multi-fiber composite. Substrate or nonwoven consists of any paper, paperboard, board, pulp materials, felt, polymeric or Pseudo-Fiber™ natural fibers formed by:

Forming Equipment used in usual and customary nonwoven manufacture, but not limited to, Airlaid, Airlace, Spunlace, Carding, Needlepunch, Apex or Miratec technologies.

Thermoforming Equipment:

Pressure-Forming Equipment:

Ultrasonic-Forming Equipment:

Overall Effect of Dry-Processing upon Fibrous and Non-Fibrous Waste Materials:

1. increases surface area of waste materials so that functional properties are more efficaciously performed

2. acts simultaneously as an absorbent material and a barrier [heat, fluid [multiple insults, sound & odor control]

3. increases flexibility of material

4. increases flexibility in achieving substrate properties of thermal-resistance, fluid acquisition, web integrity, odor control, acoustical, thermal-resistance, chemical-resistant, UV-resistant, fire-retardency, et al. and other functional properties deemed relevant to end-use products;

5. offers flexibility in additional chemical fiber treatment options; and

6. increases materials' ability to be bonded into a sheet, substrate or cellulosic fiber matrix of wood pulps, non-wood pulps, or any other cellulosic or polymeric materials, with or without binders.

Step Three: Wet or Chemical Processing: Combinant Structure

This novel process combines the processed, refined, cellulosic and/or polymeric fibers with the processed, refined, fibrous and non-fibrous waste materials, to form a multi-fiber composite.

These fibrous and non-fibrous waste materials are to be dispersed in a pulper, or similar dispersing apparatus suitable to manufacture, and then that dispersion, blended in the fan pump, or other suitable mixing point, prior to the headbox, vat or similar, of the paper-making machine or other composite manufacture.

Step Four: Composite Formation

Multi-fiber composite formation, when used with processed fibrous and non-fibrous waste materials, offers the paper, nonwovens and chemical composite manufacturers, an unusual multi-fiber matrix.

For paper and nonwoven applications, composite consists of any paper, paperboard, board, pulp or moulded pulp materials, felt, polymeric with Pseudo-Fiber™ fibrous and non-fibrous waste materials to be formed by:

A. Fordrinier-Type Machines

Single-ply substrate formed on a fordrinier-type machine with one or more forming wires, with the inclusion of Pseudo-Fiber™ natural fibers.

Multiple-wire formation can be used to produce sheets where Pseudo-Fiber™ natural fibers are introduced into one or more forming zones. These substrates can be used, as is, or laminated to produce multi-ply, layered materials.

B. Cylinder-Type Machines

The cellulosic fibrous materials would be the feed stream to the top and bottom cylinders, or vats, on a conventional cylinder machine. Usual and customary processes.

The Pseudo-Fiber™ natural fibers, with or without the inclusion of fibrous materials, would be feed streams for one, or more, top, bottom and or filler-ply cylinders, or vats, a novel process.

C. Moulded Pulp Products Equipment

A critical problem with moulded pulp products such as egg cartons, berry boxes, “yuppie” paks, etc., is the need for humidity hold-out which can be determined using a ring-crush test. As these fibrous and non-fibrous waste materials help maintain wet-web integrity when mixed with pulp, there should be significant advantages to using these fibers to resist humidity and moisture and maintain tensile strength of structure. This new fiber technology reacts well within the scope of the pulp processing equipment used in this process.

D. Other Forming Equipment, but not limited to, Wetlaid, Hydroentangled, Needlepunched, Spunlace, Apex™ or Miratec technologies.

Step Four: Converting

A. Lamination or Adhesion of two or more substrates, with or without binders, heat, or other combinatory agents or processes.

B. Application of barrier layers, of usual and customary application, of films, foils, coatings, etc., or any material used to retard the penetration of any gases, liquids, grease and oils, or any other penetrants.

C. Converting to end-use products, as usual and customary.

### BRIEF DESCRIPTION OF THE DRAWINGS

FIG. 1: [Side View] Single-ply composite with Pseudo-Fiber™ natural fibers made from fibrous and/or non-fibrous waste materials.

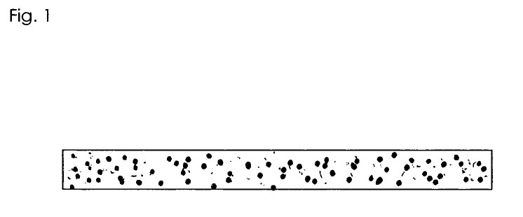

FIG. 2: [Side View] Single or multi-layer(s) with little, or no Pseudo-Fiber™ natural fibers made from fibrous and/or non-fibrous waste materials. In multi-layer composites, an alternate layer structure may contain Pseudo-Fiber™ natural fibers in one layer and a second layer may, or may not, contain these proprietary natural fibers made from waste materials.

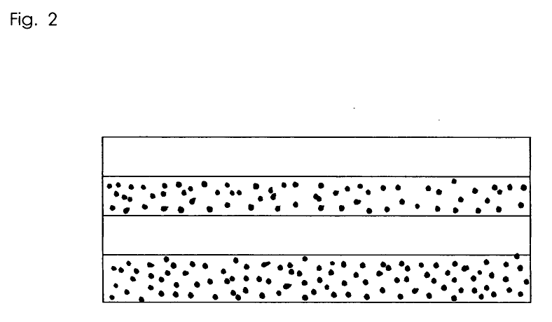

FIG. 3: [Top View] Single or multiple layer(s) of multi-fiber substrate, with proprietary Pseudo-Fiber™ natural fibers made from fibrous and/or non-fibrous waste materials.

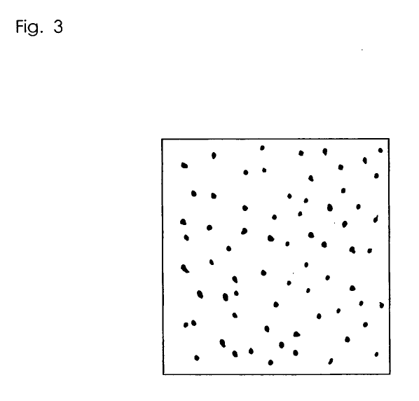

FIG. 4: [Side view] Multi-layered composite of both Pseudo-Fiber™ natural fibers made from fibrous and/or non-fibrous waste materials; both composites may contain same materials or separate materials, depending on application. Alternate layer structure may contain Pseudo-Fiber™ natural fibers in one layer and a second layer may, or may not, contain these proprietary natural fibers made from waste materials.

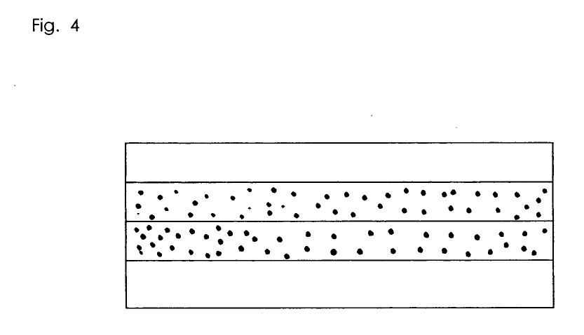

What I claim as my invention is:

I claim:

1. A composite material, comprising:
waste materials from wood, non-wood cellulosic or polymeric fibers in this invention formed from the group of Pseudo-Fiber™ natural fibers, Type A or Type B, or other family members;
a single layer, wherein it is positioned alone, or as a top, middle or bottom layer containing, or not containing, said composite waste materials, with or without binders;
double or multi-ply layer, wherein it is positioned alone, or as a top, middle or bottom layer containing, or not containing, said composite waste materials; or
multiple layers, positioned alone, or consecutively, vertically, horizontally, or alternately with, or without, layers of composite materials, with or without binders, selected from the group of waste materials, which are the subject of this invention, and alternately additional layers of material containing, or not containing, the composite waste materials.

2. The composite materials of claim 1, wherein the waste materials used in the composite, comprise an additive selected from the group consisting of flame retardants, static retardants, corrosion retardants, ultraviolet absorbers and stabilizers, biocides, sound attenuators, antioxidants, antibacterial chemicals, odor absorbers, stabilizers or retardents, vulcanizers, impact modifiers, fillers, super absorbent polymers, tensile strength polymers, and combinations thereof.

3. The composite materials of claim 1, wherein the waste materials used in the composite, comprise multiple layers, with layers containing, or intermittently, not containing waste materials, may be joined by lamination, application of barrier layers of films, polymer films, foils, coatings, heat seaming, heat lamination, pressure or thermobonding, ultrasonic seaming, factory solvent seaming, electrical conduction seaming, electromagnetic induction seaming, electrical resistance seaming, and combinations thereof.
